(19) United States
(12) Patent Application Publication
(10) Pub. No.: US 2002/0049867 A1
(43) Pub. Date: Apr. 25, 2002

(54) Application transfer method, application transfer system and storage medium therefore

(76) Inventor: Yoshitomo Kumagai, Yokohama (JP)

Correspondence Address: STAAS & HALSEY LLP, 700 11TH STREET, NW, SUITE 500, WASHINGTON, DC, 20001, US

(21) Appl. No.: 09/771,875

(22) Filed: Jan. 30, 2001

(30) Foreign Application Priority Data
Aug. 29, 2000 (JP) 2000-259225

(51) Int. Cl. G06F 9/46; G06F 9/00; G06F 9/44

(52) U.S. Cl. 709/319

(57) ABSTRACT

The invention relates to a method for transferring applications to a different platform, which prevents creation of GUI definition at the target platform. With the present invention, GUI definitions for target applications can be automatically created from GUI definitions in original applications because the GUI definition file 35 for the original application 1 is used to display menus and create a GUI definition file 34 for the application in the target environment to which GUI information obtained from the displayed statuses has been added.

### BACKGROUND OF THE INVENTION

1. Field of the Invention

The present invention relates to a method and system for transferring application programs created in one platform to other platforms, and more particularly to a method and system for transferring an application so that the graphical user interface (GUI) menu data for that application can be used.

2. Description of the Related Art

FIG. 11 is a schematic view of an application and is used to explain the conventional art. An application program (hereinafter referred to as an application) in one operating system (OS) cannot be used, as is, in another OS environment. To use this application in another OS environment, the application must be transferred to the other environment. Below an example of the transfer of a UNIX workstation (WS) application to a Windows personal computer (PC) application will be explained.

For example, a UNIX application program 100 created in UNIX using X11/Motif (first platform) 120 has X11/Motif dependent part 110. Conversely, a Windows NT application program 200 has a Windows NT dependent part 210.

The following types of method have been used to transfer this UNIX application 100 to Windows NT.

(1) The X11/Motif dependent part 110 of the application 100 is all rewritten to a Windows NT dependent function.

(2) The application 100 operates as is, using a tool (program) that emulates the X11/Motif dependent part 110 to enable the Windows NT dependent part to operate.

However, the former method requires each application to be rewritten and therefore when there is a plurality of applications to be transferred, the volume of material to be rewritten will be huge. The latter method requires users to purchase an emulation tool and the emulation tool must always be running when the application is executed. Furthermore, if an error occurs in the emulation tool, emulation is disabled or requires a great deal of time.

Therefore, it has been proposed that an interface layer that mediates between applications and platforms be established so that creation of an application using that interface will enable transfer of that application to another platform merely by rewriting the interface part.

In recent years, applications come with a graphical user interface (GUI) that makes it easy for users to use them. A GUI displays the desired menus using GUI definitions. The contents of GUI definitions differ according to the GUI tool used and when the GUI tools used in the original platform and the target platform are different, deficiencies in the information required arise and creation of the correct menus in the target platform becomes difficult.

For example, when transferring the UNIX application program 100 created using X11/Motif (first platform) 120 in UNIX to Windows NT (second platform), only the position and size of the outside frame of the menu are defined in the X11/Motif GUI definitions. The positions and sizes of menu components are not defined. However, in Windows NT the position and size of components are required when components are created for menus.

In addition to component position and size, other information that defines the GUI includes colour, font name, drawing direction, arrays, shade, pixel map names, relationships between components (hierarchical relationships), component positioning methods, behaviour of components when their size is changed, component statuses (on/off), scales, and values and character strings of components themselves, such as text components.

In conventional art, when there is insufficient GUI definition information in the new platform, this information must be entered manually. That requires a large amount of work.

### SUMMARY OF THE INVENTION

Accordingly, an object of the present invention is to use the GUI definitions of an application program created in the original platform in the target platform and thereby provide a method and system for transferring an application so that the same menus are generated.

A further object of the present invention is to provide an application transfer method and system for transferring application programs with little effort.

To achieve these objects, the application transfer method of the present invention comprises a step that uses the GUI definition file of the application in the original platform to display menus and confirm statuses in the environment of that original platform, and a step that creates a GUI definition file for the application in the target environment to which GUI information obtained from the displayed statuses has been obtained.

In the present invention, the GUI definition file of the application in the original platform is used to display the menus. The creation of a GUI definition file for the application in the target environment to which GUI information obtained from the displayed status has been added, enables the GUI definitions for the application in the target platform to be automatically created from the GUI definitions for the applications in the original platform.

Also, in the present invention it is preferable to further comprise a step of rewriting the interface layer for the application in the target environment so that the above GUI definition file is read. The application to the target platform enables menus to be displayed using GUI definitions.

Furthermore, in the present invention, it is preferable that the creation step comprises a step of creating the GUI definition file of the application in the target platform to display the created menus by using the GUI definition file for the application in the original platform environment. This enables all menu contents to be transferred.

It is also preferable in the present invention that the above confirmation step comprises a step for fetching the positions and sizes of components as displayed in windows by looking sequentially at all windows in the menu from the parent window through sub-windows. Furthermore, the creating step comprises a step of creating the GUI definition file by outputting the positions and sizes of components. This enables an automatic transfer of the GUI definition by using windows hierarchy.

### BRIEF DESCRIPTION OF THE DRAWINGS

FIG. 1 explains the application transfer method used in an embodiment of the present invention;

FIG. 2 is a schematic view of the interface layer of FIG. 1;

FIG. 3 explains the interface layer of FIG. 2 when a menu is specified;

FIG. 4 explains the interface layer of FIG. 2 when a figure is drawn;

FIG. 5 is a schematic view of the GUI definition conversion system of FIG. 2;

FIG. 6 shows the flow of processing in the GUI definition conversion program of FIG. 5;

FIG. 7 is a schematic view of the GUI definition hierarchy;

FIG. 8 explains an example of a GUI definition menu of FIG. 7;

FIG. 9 explains the GUI definition in the X11/Motif of FIG. 5;

FIG. 10 explains the Windows NT GUI definition that has been converted from the GUI definition in FIG. 9; and

FIG. 11 explains conventional application transfer methods.

### DESCRIPTION OF THE PREFERRED EMBODIMENTS

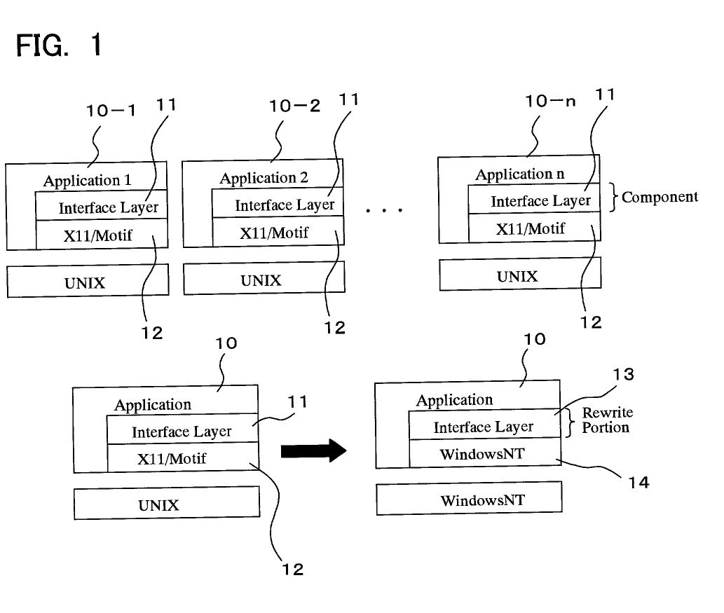

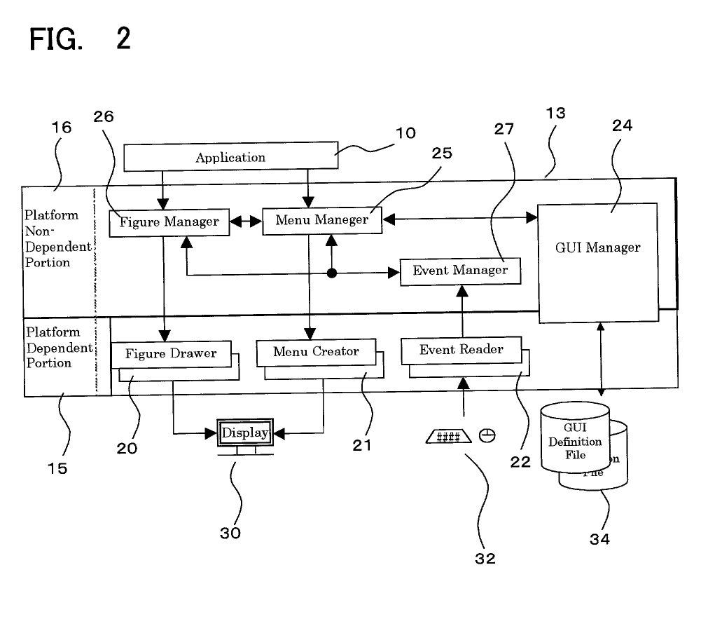

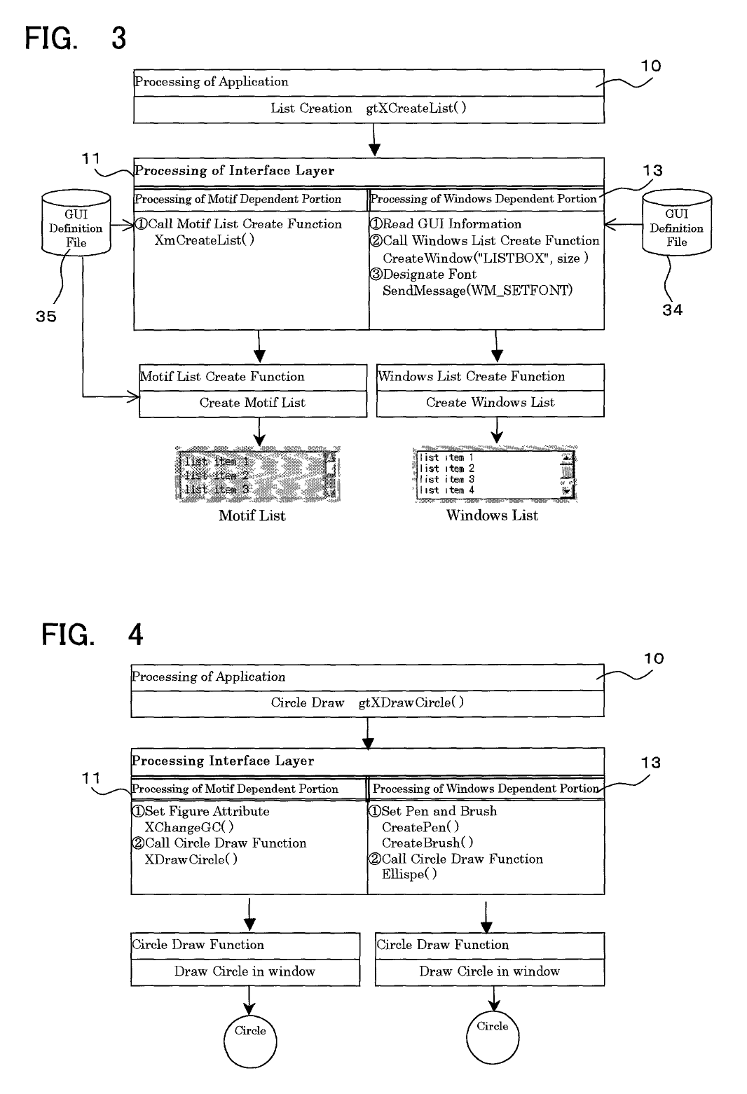

FIG. 1 explains the application transfer method used in an aspect of the embodiment of the present invention. FIG. 2 is a schematic view of the interface layer, and FIGS. 3 and 4 explain the interface layer of FIG. 1.

FIG. 1 shows an example where UNIX applications 10-1 through 10-n are transferred to Windows NT. As shown in FIG. 1, the X11/Motif dependent parts of the UNIX applications 10-1 through 10-n, which are created using X11/Motif (first platform) 12, are configured in a compartmentalized interface (library) layer 11 so that they can be commonly used from a plurality of applications.

To transfer an UNIX application 10 to Windows NT, the interface layer 11 for the X11/Motif dependent part is recreated in the Windows NT interface layer 13. This interface layer 13 is divided into a non-platform dependent layer and a platform dependent layer. The platform dependent layer uses Windows NT dependent functions and the non-platform dependent layer is rewritten for Windows NT.

FIG. 2 is a schematic view of the interface layer 13 of a rewritten Windows NT application program 10. As shown in FIG. 2, the interface layer 13 comprises a platform dependent part 15, which is dependent on Windows NT, and a non-platform dependent part 16 that is written for Windows NT.

The platform dependent part 15 comprises a figure drawer 20 for drawing figures, a menu creator 21 for creating menus, and an event reader 22 that reads events from the keyboard and mouse. This platform dependent part 15 uses Windows NT dependent functions.

The non-platform dependent part 16 comprises a GUI manager 24 that reads GUI information from the GUI definition file 34, an event manager 27 that analyses the events in the event reader 22, a menu manager 25 that analyses menus specified by the application itself 10 and the event manager 27 and that reads GUI information, and a figure manager 26 that analyses figures specified by the application itself 10 and the event manager 27. The non-platform dependent part 16 does not rely on Windows NT.

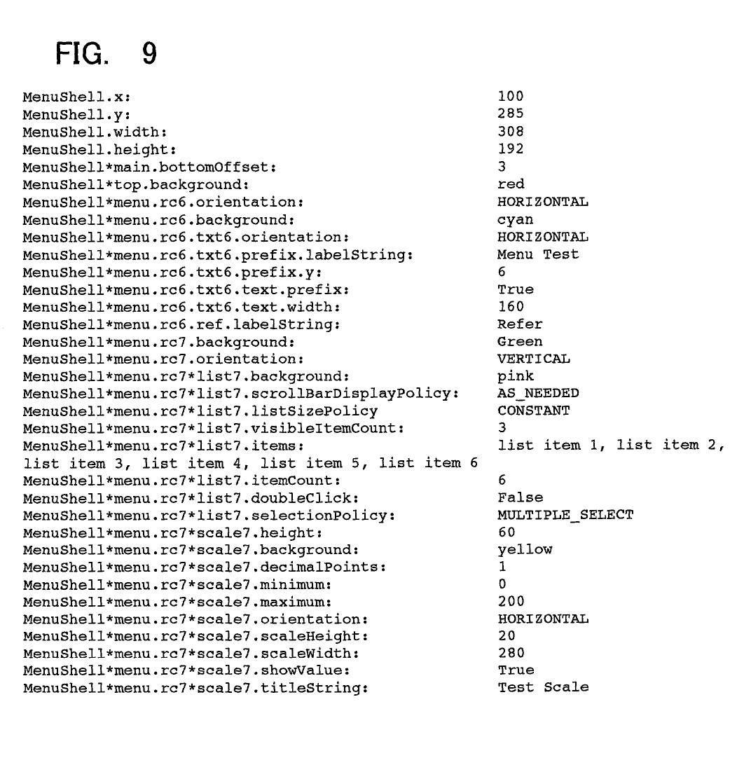

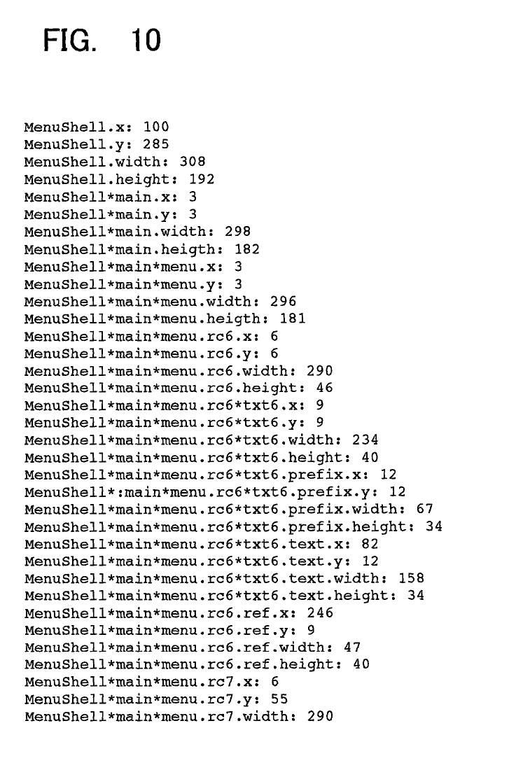

FIG. 3 and FIG. 4 explain the interface layers 11 and 13 shown in FIG. 1 and FIG. 2. FIG. 3 explains the processing of the interfaces 11 and 13 for creating a menu when the application 10 prompts a list to be created (gtXCreateList( )). As shown in FIG. 3, when the application 10 prompts a list to be created, a Motif list creation function (XmCreateList( )) is called in the interface layer 11 of the UNIX application 10. The Motif list creation function creates a Motif list from the list information (details are given below in FIG. 9) in the GUI definition file 35.

In contrast, when the application 10 prompts a list to be created, in the interface 13 of the Windows NT application 10, GUI information is read from the GUI definition file 34, a Windows list creation function (CreateWindow(ListBox, Size)) is called, and a font is specified (SendMessage (WM#SETFONT). In other words, position, size, and font are specified in the Windows list creation function. The Windows list function uses position, size, and font to create a Windows list.

Thus, GUI information (position, size, font) is needed when creating menus in Windows and the interface layer 13 must have a function for reading this information.

Next, FIG. 4 is used to explain figure drawing. As shown in FIG. 4, when the application 10 prompts a circle to be created, in the interface layer 11 of the UNIX application 10, a drawing attribute (XChangeGC( )) is specified and a circle drawing function (XDrawCircle( )) is called. The X11 circle drawing function then draws a circle in the window.

On the other hand, when the application 10 prompts a circle to be created, in the interface layer 13 of a Windows NT application 10, a pen and brush are set (CreatePen( ), CreateBrush ( )) and a circle drawing function (Ellipse( )) is called. The Windows circle drawing function then draws a circle in the window. The interface layer 13 is thus rewritten.

Next, as explained above, in a X11/Motif GUI definition only the position and size of the menu frame are defined. Positions and sizes of each component of a menu are not defined. However, in Windows NT, when components to be placed in a menu are created, their position and size are required. In the present invention, X11/Motif GUI definitions are used as they are and Windows NT component (menu lists, etc.) position and size information is added.

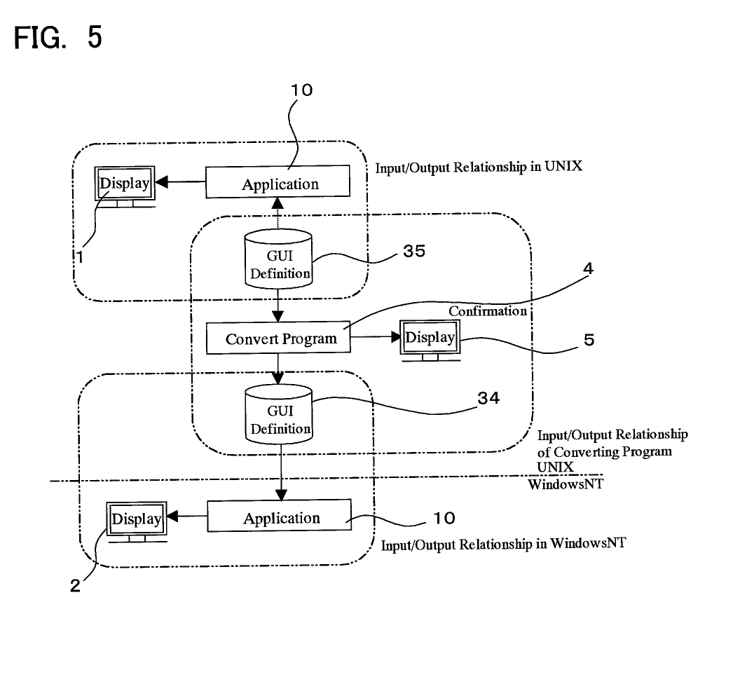

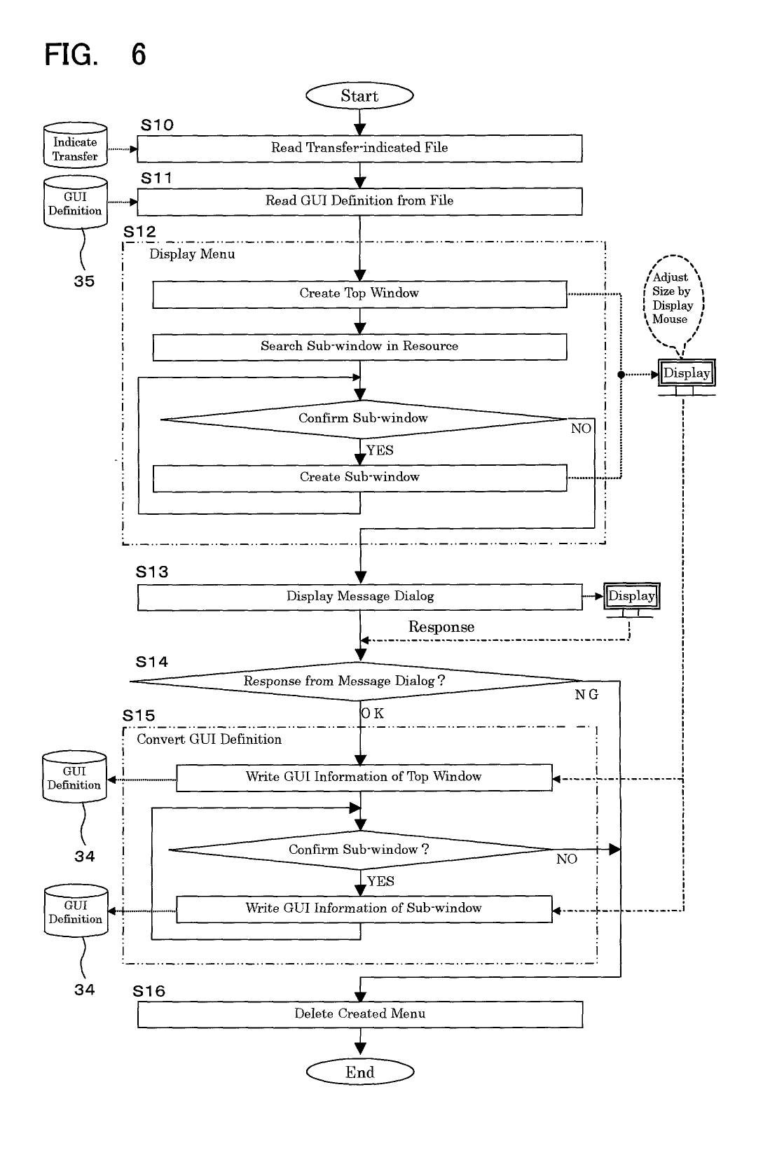

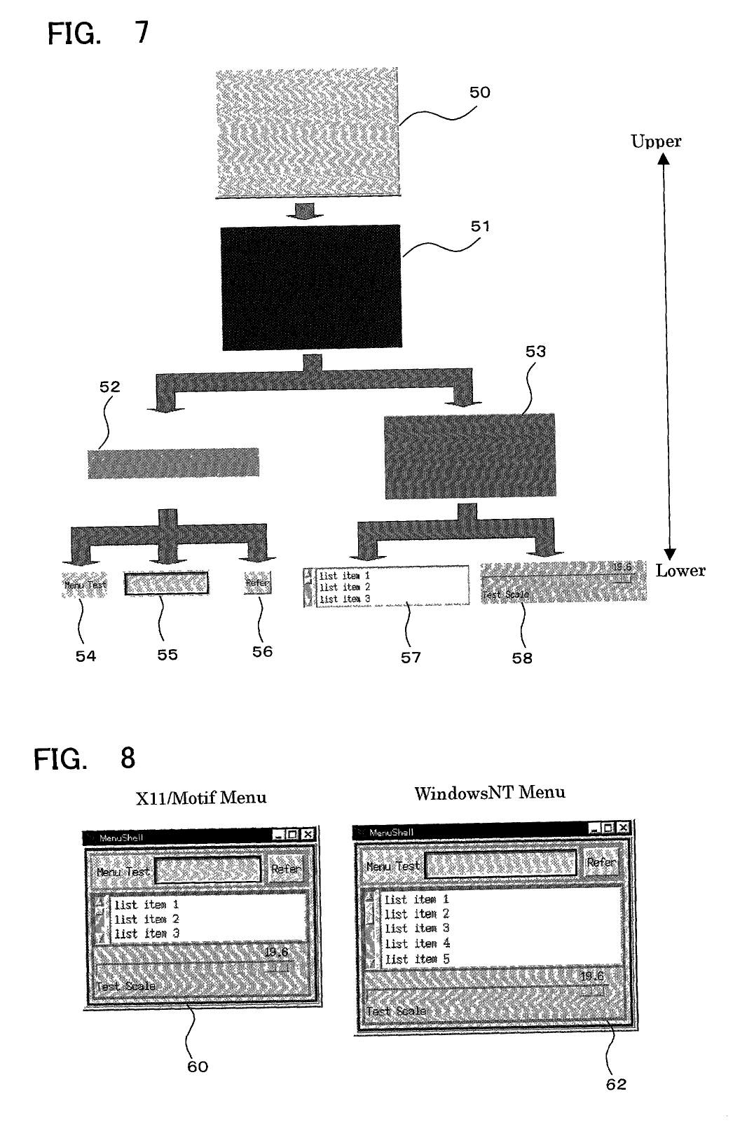

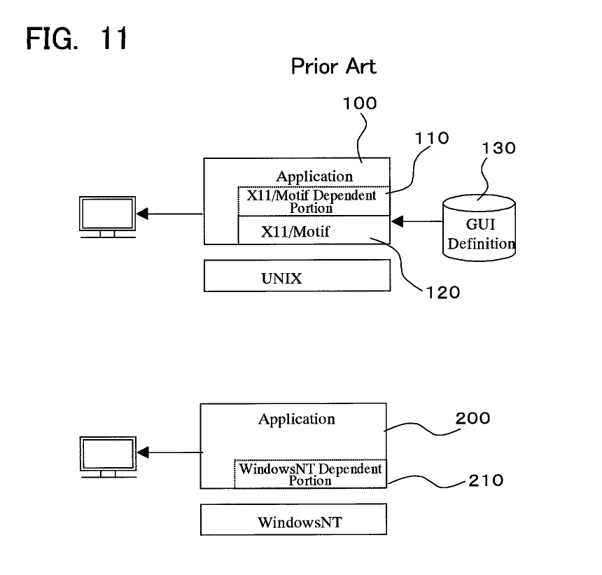

FIG. 5 is a schematic view of the GUI conversion tool for an aspect of the embodiment of the present invention. FIG. 6 shows the flow of processing in the conversion program of FIG. 5. FIG. 7 explains the operation of the conversion and FIG. 8 explains an example of a conversion menu. FIG. 9 explains GUI definitions in X11/Motif and FIG. 10 explains these GUI definitions after conversion for Windows NT.

As shown in FIG. 5, in the relationship between input and output in a UNIX environment, the UNIX application 10 displays on the display device 1 in menus and figures using X11/Motif GUI definitions 35. In the relationship between input and output of a Windows NT environment, the Windows NT application 10 displays on the display device 2 in menus and figures using GUI definitions 34.

In the UNIX environment, the GUI definitions conversion program 4 uses X11/Motif GUI definitions 35 and adds the positions and sizes of components (menu lists, etc.) for which there is inadequate information in the X11/Motif GUI definitions. It then creates a GUI definitions file 34.

Specifically, the menu created by reading the GUI definitions 35 starts in the parent window and sub-windows are sequentially arranged in a hierarchical manner. Therefore, users can follow the windows from the parent window down through sub-windows. The position and size of each of those windows is fetched by going through all windows and output according to the format described in the GUI definitions. This generates a GUI definition file 34 that contains positions and sizes.

More specifically, FIGS. 7 and 8 will be used explain the GUI definition conversion program 4 from FIG. 6.

(S10) The conversion prompt file that prompted conversion on the display device 5 is read.

(S11) The GUI definition information is read from the file 35.

(S12) The menu is then created and displayed using the GUI information thus read. In other words, the prompt from the display device 5 creates the uppermost window using the GUI information read and then displays that window. The mouse for the display device 5 is used to adjust the size of the window. The GUI information for this uppermost window is stored. Specification information for sub-windows is then fetched from within resources. The existence of sub-window specifications is confirmed. When there are none, processing proceeds to step S13. When there is a sub-window specification, the sub-window is created and displayed using the GUI information read. The mouse for the display device 5 is used to adjust the size of the window. The GUI information for this sub-window is stored and processing is repeated.

The X11/Motif menu 60 in FIG. 8 is, as shown in FIG. 7, arranged hierarchically from the top window 50 down through sub-windows 54 through 58. Accordingly, by displaying windows starting from the top window 50 down to window 58, the GUI information (menu) for each window can be acquired.

(S13) Next, a message dialogue for confirmation is displayed and a response is awaited.

(S14) The response from the message dialogue is studied. If an NG response is received, processing proceeds to step S16.

(S15) If the response from the message dialogue is OK, the acquired menu information is converted into GUI definition information. In other words, the GUI information for the top window is fetched and written into the GUI definition file 34. The existence of sub-windows is confirmed. If there are none, processing proceeds to step S16. If there is a sub-window, the GUI information for the sub-window is fetched and written in the GUI definition file 34. Processing is then repeated.

(S16) The menu created is deleted. And processing ends.

FIG. 9 is an example of an X11/Motif GUI definition. FIG. 10 is a GUI definition in which position and size has been added to the FIG. 9 GUI definition. In the X11/Motif GUI definition of FIG. 9, only the position and size of the menu frame (x, y, width, height) are defined. The positions and sizes of each of the components of the menu (menu, rc6, txt6, list7, scale7) are not defined.

In the Windows NT GUI definition of FIG. 10, the position and size of the menu frame (x, y, width, height) are defined, as are the positions and sizes of each of the menu components (menu, rc6, txt6, list7, scale7).

In this way, the positions and sizes of components (menu lists etc.), for which GUI definitions are inadequate, are added to the X11/Motif GUI definitions 35 to enable a GUI definitions file 34 to be created.

Also, the menus created when the GUI definitions 35 are read place the parent window at the top and then sequentially arrange sub-windows in a hierarchical fashion. Therefore, a GUI definition file 34 containing positions and sizes can be automatically generated by going from the top parent window through the subsequent sub-windows, fetching positions and sizes for those windows as displayed, and displaying them in accordance with the format described in the GUI definitions.

In the above aspect of the embodiment of the present invention, an example of a UNIX application using X11/Motif being converted into a Windows application using WIN32API has been explained. However, the present invention can also be applied to the transfer between other GUI tools, which can be acquired from states that display GUI definition information, and various OS. For example, in addition to X11/Motif and WIN32API GUI tools, the present invention can be applied to X/View (OpenWindow), SunView, and Java tools. Applications can be transferred between UNIX (Solaris, FreeBSD, Linux), Windows (NT/95/98/2000), MacOS, and OS/2.

An aspect of the embodiment of the present invention has been explained above but there are various modifications of the present invention within its technical scope. These shall not be excluded from the technical scope of the present invention.

What is claimed is:

1. An application transfer method for transferring an application from an original environment to another target environment, comprising:
a step of displaying a menu by using a GUI definition file for the application of said original environment; and
a step of creating another GUI definition file for the application in said target environment to which GUI information obtained from said displayed status is added.

2. The application transfer method according to claim 1 further comprising a step of rewriting an interface layer of the application in said original environment so that said another GUI definition file is read in said target environment.

3. The application transfer method according to claim 1 wherein said creation step comprises a step of creating said another GUI definition file so that the created menus can be displayed in said target environment by using said GUI definition file.

4. The application transfer method according to claim 1 wherein said displaying step comprises a step of sequentially searching from a parent window from a sub-window of said menu and fetching the position and size of each window in said displayed status,
and wherein said creation step comprises a step of outputting said fetched positions and sizes and creating said another GUI definition file.

5. The application transfer method according to claim 1 wherein said original environment is a UNIX operating system and wherein said target environment is a Windows operating system.

6. An application transfer system that transfers an application from an original environment to a target environment, comprising:
a GUI definition file for said original application;
a display device; and
a creating means for displaying a menu by using the GUI definition file for said original application in said original environment, adding GUI information obtained from said displayed status, and then creating an another GUI definition file for the application in the target environment.

7. The application transfer system according to claim 6 wherein the creating means rewrites the interface layer of the application in said original environment so that said another GUI definition file is read in said target environment.

8. The application transfer system according to claim 6 wherein said creating means uses the GUI definition file for said original application and creates said another GUI definition file for application in said target environment so that created menus can be displayed.

9. The application transfer system according to claim 6 wherein said creating means searches sequentially through windows in said menu from a parent window through a sub-window, fetches positions and sizes found in the displayed statuses of those windows, outputs said fetched positions and sizes and creates said another GUI definition file.

10. The application transfer system according to claim 6 wherein said original environment is a UNIX operating system and said target environment is a Windows operating system.

11. A storage medium stored an application transfer program for transferring an application from an original environment to another target environment, said program comprising:
a first program of displaying a menu by using a GUI definition file for the application of said original environment; and
a second program of creating another GUI definition file for the application in said target environment to which GUI information obtained from said displayed status is added.
